(19) United States
(12) Patent Application Publication
(10) Pub. No.: US 2006/0265175 A1
(43) Pub. Date: Nov. 23, 2006

(54) Low-cost multi-span conductor temperature measurement system

(76) Inventor: Manuchehr Shimohamadi, Castro Valley, CA (US)

Correspondence Address: BELL & ASSOCIATES, 416 FUNSTON ST., SUITE 100, SAN FRANCISCO, CA, 94118, US

(21) Appl. No.: 11/430,703

(22) Filed: May 8, 2006

Related U.S. Application Data
(60) Provisional application No. 60/679,045, filed on May 9, 2005.

(51) Int. Cl. G06F 15/00

(52) U.S. Cl. 702/130

(57) ABSTRACT

A temperature sensing device adapted for attachment to a suspended line employing a sonar pulse propagated through the length of the line wherein the reflection of the pulse along the line is proportional to the temperature of the line.

This application claims the benefit of and priority to U.S. provisional application 60/679,045 which was filed in the USPTO on 9^{th} May 2005, which is hereby incorporated by reference for all purposes.

### BACKGROUND

### Problem Statement

Overhead transmission lines used to conduct electricity have ampacity (electrical current capacity) limitations which are primary temperature based. In practical terms, these thermal limits are expressed are either as a minimum clearance of the line from the ground (“line sag”) or material based, e.g. the annealing limits for the conductor, which is frequently aluminum. To comply with these thermal limits, utilities or operators of transmission lines generally limit the line current to some pre-calculated values based on the overall line design and conformation in use. This generally translates to de-rating the line current on hot and low wind days based on the estimated line temperature. More and more, utilities are seeking and implementing methods to better rate their lines on a dynamic (“Dynamic Rating”) or semi-dynamic (“Quasi-Dynamic Rating”) basis. Such methods rely on estimating the conductor temperature by continuous or semi-continuous monitoring of ambient conditions, sag, or tension of the line. No only are these methods expensive, but they also can provide misleading information as such measurements ate generally local, and line characteristics can vary significantly from span to span and even within the same span.

In an overhead conductor (for example a line spanning between two towers), line tension, and line sag are all proportional to conductor temperature as well as conductor material, size, and its installation. For a given conductor in a given installation, if two of the variables are known (e.g. sag, tension, or average conductor temperature) for any given state (for example, the initial installation state), all other variables can be determined from a single measurement of one of these remaining variables. That is if one were to measure only line sag at a given location, line tension, or the average conductor temperature for a given state, the other two variables could also be calculated for that state from the use of mathematical equations (e.g. catenary equations).

Currently, methods exist for measuring line sag (such as EPRI's Video Sagometer) and line tension (such as the CAT system). Both these methods are very expensive. Also, methods exist for measuring conductor temperature at a given location, however, it is known that the temperature within even one span can vary by a significant amount and hence the average conductor temperature is not readily measurable nor is it economically feasible using currently available methods. Conductor temperature can also be estimated (calculated) from measurement of environmental (ambient temperature, wind speed, and solar radiation) and the current (Amps) in the conductor using accepted industry methods (such as IEEE methods). However, these methods are not exact, and more importantly, measurement of ambient conditions have the same deficiency as direct measurement of the conductor temperature discussed above.

Therefore, a need does exist for a reliable and low cost method to measure the conductor temperature over a long distance.

### BRIEF DESCRIPTION OF THE INVENTION

The invention encompasses a temperature sensing device comprising: a mounting system (3), such as a clamp, adapted for attachment to a line (7) such as a conductor and/or to a structural support supporting a line (such as a tower), the clamp comprising a clamping (attachment) portion and a frame portion of any sort or shape suitable for holding and retaining the other components; a sonar pulse generator (1) affixed to the mounting clamp (3); an acoustic sensor and/or transducer (2) affixed to the mounting clamp (3) or to another mounting clamp or to another component; a control module (4) attached to the mounting clamp or other component communicably linked to the acoustic sensor (2); a communication module (5) attached to the mounting clamp or other component communicably linked to the control module (4), and a power module (6) attached to the mounting clamp or other component in communication with at least one of the aforementioned components so as to supply power to one or more components.

### DESCRIPTION OF THE DRAWINGS

FIG. 1 shows a schematic of the device including a sonar pulse generator (1), an acoustic sensor and/or transducer (2), a mounting system (3), a control module (4), a communication module (5), and a power module (6).

FIG. 2 shows one possible arrangement of the new device on a multi-span line. The transmitter module (9A) contains a sonar pulse generator (1), mounting clamp (3), control module (4), communication module (5), and power module (6). The receiver module (9B) contains an acoustic sensor and/or transducer (2), mounting clamp (3), control module (4), communication module (5), and power module (6). A master control unit (10) is located on a tower (11), a nearby structure, or a remote structure, and contains a control module (4), communications module (5), and a power module (6). “Raw” data, which may include waveform characteristics, and transit times of the acoustic pulse, are transmitted from the transmitter module (9A) and the receiver module (9B) to the master control unit (10). The master control unit then converts the “raw” data into “processed” data which may include line length, sag and temperature information, and then communicates that data to the utility's operation station for dynamic rating purposes. Alternatively, “raw” data may be converted to “processed” data by the control modules (4) at the transmitter module (9A) and the receiver module (9B) before transmitting to the master control unit (10); or “raw” data may be transmitted all the way to the utility's operation station before being processed.

FIGS. 3A and 3B shows one of the more preferred embodiments for this invention. In this embodiment, conductor (7) is shown hung from the tower insulator (12) by standard hardware (13). An acoustic transceiver module (9) has components in two housings. Item 9R on the right consists of a sonar pulse generator (1), an acoustic sensor and/or transducer (2), a mounting clamp (3), and an inductive coil power module (6). Item 9L on the left consists of a control module (4) and a communications module (5). Items 9R and 9L are connected via a communication and a power cable (14). Alternatively, 9L could be a master control unit (10) meaning it would communicate with other transceivers on the line as well as the utility's operation station.

FIG. 4: Graphic representation of acoustic signal received by transducer.

FIGS. 5, 6 and 7 are block diagrams describing three possible embodiments of the current invention.

### DETAILED DESCRIPTION OF THE INVENTION

The invention is based on the simple concept of using a sonar pulse-echo technique on the line that measures line length based on time-of-flight for the signal and its echoes to travel between the pulse generator and pulse detector. This invention is named MASTS for Multi-span Acoustic Sonar Temperature measurement System.

Components of the Invention

The major components (modules) of this invention include:
1) Acoustic Pulse Generator: This module generates acoustic (sonic or ultrasonic) pulses. Examples include piezoelectric and electromagnetic pulses.
2) Acoustic Sensor (Transducer): This module detects acoustic pulses on the conductor. Examples include piezoelectric, electromagnetic, capacitive and acousto-optic transducers, fabricated by traditional means or micromachining.
3) Mounting Clamp: These are specially designed mounting systems that transfer the pulse or its echoes to and from the conductor in an efficient manner.
4) Control Module (Microprocessor Unit): This component controls pulse generation and echo measurements, performs temperature calculations using time-of-flight between pulse and echoes, stores data in solid state memory (such as flash memory, RAM, or EEPROM, or a magnetic storage device such as a hard drive) and provides a means of communication with a user interface (such as a computer, data logger, or data storage device such as an external hard drive or flash drive). This module also has an ambient temperature sensor, such as a thermocouple or RTD, built into it.
5) Communication Module: This module transfers raw data (such as acoustic pulse wave characteristics and transmit times, and climate data) or processed data (such as conductor temperature, length or sag) to a local or remote station using radio frequency communication means such as a short wave radio, a cellular device, a microwave device, satellite communication, or infrared.
6) Power Module: Components of this invention are powered by one or more power units. The Power Module can be simply an inductive coil wrapped around the power line to transform and transfer the electrical power of the line to the required power of all the other modules of the invention. Alternatively, the Power Module can be a combination of an energy gathering/energy storage system as described below:
   a. The energy gathering system collects energy to be transferred directly or indirectly to the energy storage system. Energy may be transmitted directly from the energy gathering system to the point needed, or may be stored, for example in a battery or capacitor. The energy gathering system may comprise (but is not limited to) one or more of the following:
      a wind driven turbine that transforms kinetic wind energy into rotary motion of a shaft though a system of gears;
      a pendulum attached to a backstopping clutch and a gear (similar to a self winding watch mechanism) that transforms line vibration, such as Aeolian vibration, to circular motion of a shaft;
      a shape memory alloy (SMA) actuator which transforms ambient temperature variations into motion, e.g., a circular motion of a shaft (e.g., a SMA may be linked to a spring or gear/cog mechanism such that the expansion and/or contraction of the SMA causes, for example, a spring to become wound, thus storing potential energy in the spring, which may be subsequently released);
      a solenoid which transfers line vibration, such as Aeolian vibration, into electricity, e.g. a magnet inside a conductive coil such that as line vibrates with wind (Aeolian vibration), the magnet moves back and forth inside the coil causing electricity to be generated;
      a photovoltaic cell which transfers sun radiation into electric energy (which then can be used immediately to produce vibration or stored in a battery and later converted to kinetic energy via a motor);
      a direct wire tap to the power line that pulls power from the line directly, or
      an inductive coil wrapped around the power line to gather electrical energy.
   b. The energy storage system stores either mechanical or electrical potential energy gathered by energy gathering system for use. The energy storage module may be, but is not limited to
      a system of batteries for electrical energy storage, or
      a system of capacitors for electrical energy storage
      a spring or coil system for storing potential energy.

Ways to embody these components should be a matter of routine to one of skill in the mechanical and electrical engineering arts, and they will not be discussed in fine detail in this disclosure.

How the Invention Works

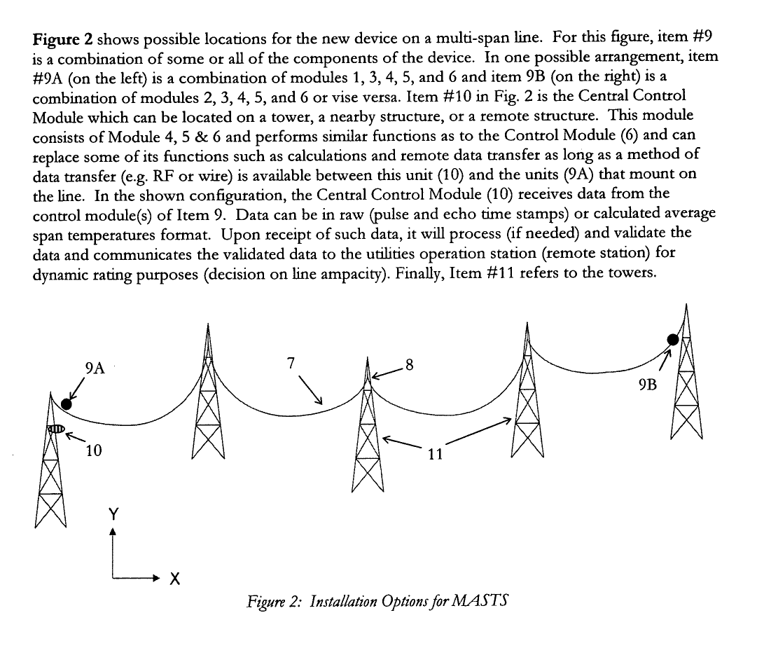

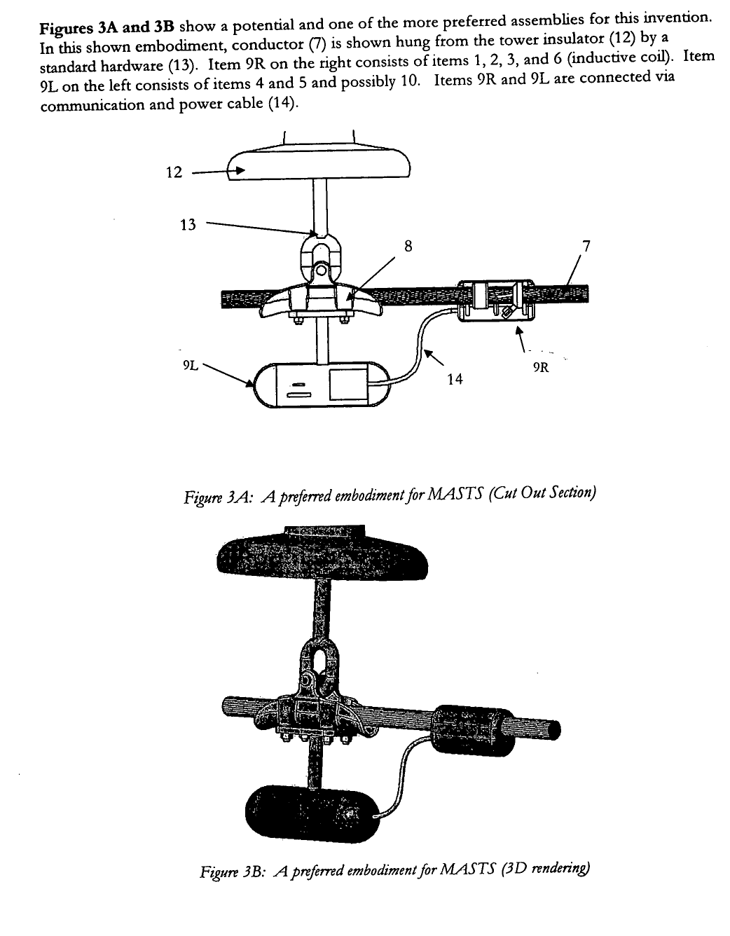

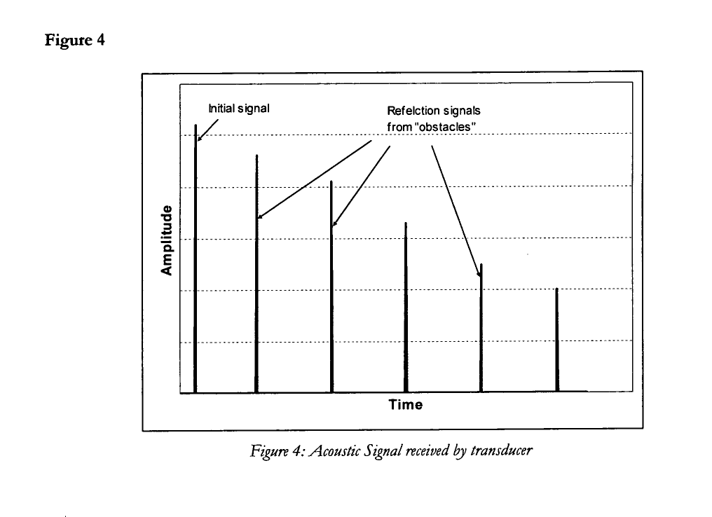

In this invention, a new method for determining the temperature of a suspended line is based on measuring the average conductor temperature using sonar-acoustic methods. The speed at which a sonic wave propagates along a line is proportional to the temperature of the line. In this invention the sonar pulse generator (1) will be placed on the conductor (7) at a given location on a span via a specially designed mounting system (3) that transfers the pulse to the conductor (e.g. angular contact with proper coupling). The pulse generator will generate acoustic pulses at a preset interval, for example, every 1, 2, 5, 10, 15, 20, 30, or 60 minutes. The pulse travels along the line in form of both surface and axial acoustic wave. As the pulse reaches an obstacle, such as an insulator clamp, part of the signal continues to travel forward (as long as the line is continuous through the clamp) and part of it will be reflected due to geometric constraints at the clamp. There will be additional reflections as the signal reaches other obstacles such as other clamps on adjacent towers. The original signal and its reflections at every obstacle will be detected (FIG. 4) by the acoustic transducer (2) which will convert the acoustic wave into an electrical signal, and which can be located at a given location on the conductor at, near, or far away from the pulse generator (FIG. 2).

The travel time (t) of the signal is a function of travel distance (x) and the speed of sound (V) in the conducting material (t=x/V). Both the length that the acoustic wave must travel (x) and speed of sound in a material (V) are functions of the temperature of the material. Therefore, time difference between pulse generation and detection of the echoes is a measure the temperature of the conductor. Unfortunately, measuring the time change alone does not allow for determining the individual effect of length change and speed of sound change. However, since the length change has a second order effect compared to the change in the speed of sound (both resulted from the same change in temperature), neglecting the length change will have minor error in determining the conductor average temperature. The example below explains this concept.

Example: Consider a pulse generator and a transducer attached to an aluminum conductor with an initial temperature of 100° F., and located 500 feet along the conductor from a clamp. The acoustic signal will travel 1000 feet before its reflection from the clamp is received. Since the speed of sound in aluminum at 100° F. is c.23320 ft/second, 42,882 μ-secsonds will pass before the transducer detects the acoustic wave reflection from the clamp.

Now, if the material temperature rises by ΔT, and assuming free thermal expansion, the line length will increase to L_{f}=L₀*(1+α*(ΔT)). For a 10° F. rise, Lₒ of 500′ and α of 11*10⁻⁶ in/in/° F., L_{f} will be 500.055′. The signal now has to travel 1000.110′. Three cases are evaluated:
Ignoring the change in speed of sound, it will take 42,886 μ-sec to detect the reflection, a change of c.4 μ-sec from previous measurement.
Ignoring the change in length and only considering the change in speed of sound (23,816 ft/sec at 110° F.), it will take 41,989 μ-sec to detect the reflection, a change of c.893 μ-sec.
Considering both changes (length and speed of sound), it will take 41,993 μ-sec to detect the reflection, a change of ˜888 μ-sec.

This example shows the error caused by ignoring the length change is less than c.0.5% in determining the conductor average temperature. Therefore, ignoring the length change can be safely tolerated.

For this invention, a “catalogue” of acoustic signal characteristics (velocity, amplitude decay, reflection strength from various discontinuities, such as clamps) for various conductors, and as a function of conductor temperature, will be developed. During the installation of the invention on a given conductor, a calibration of the signal characteristics as a function of known conditions (line length in the span, average conductor temperature, ambient conditions, current, etc.) will be performed. This initial condition will then be used to estimate the average conductor temperature at all other conditions.

Other Applications of the Invention

This invention can also be used to monitor and detect damage to the conductor for reliability purposes. This is achieved as damage, in form of cracks in the conductor, corrosion products or corrosion pitting on the conductor, or other damage that can impact the local geometry or characteristics of the conductor, will produce a reflection of the acoustic wave. This “unexpected” reflection, if occurs consistently, can be the sign of an abnormality with the conductor. The location of this abnormality can be pinpointed from time of flight values by a simple calculation and the utility can perform an inspection of the suspect area for damage. By detecting such damage and performing proactive maintenance, utilities can significantly reduce the potential for conductor failures and avoid costly and dangerous outages. Although the examples given herein relate generally to a suspended electrical power line, there is no reason why the current invention should not be used with any suspended type of line, whether suspended or not.

Various Alternative Embodiments of the Invention

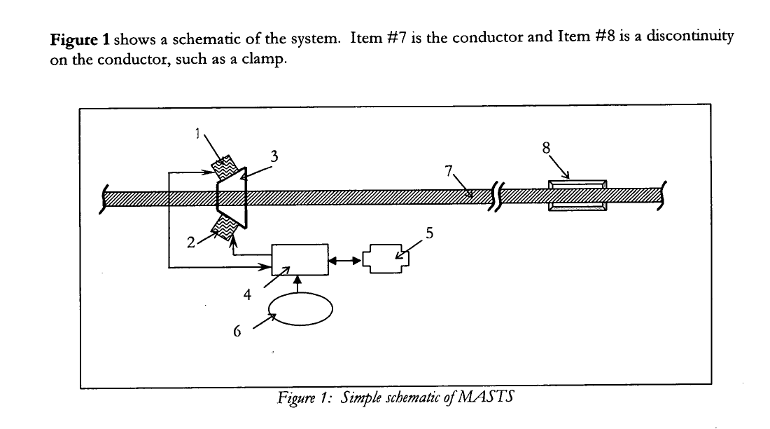

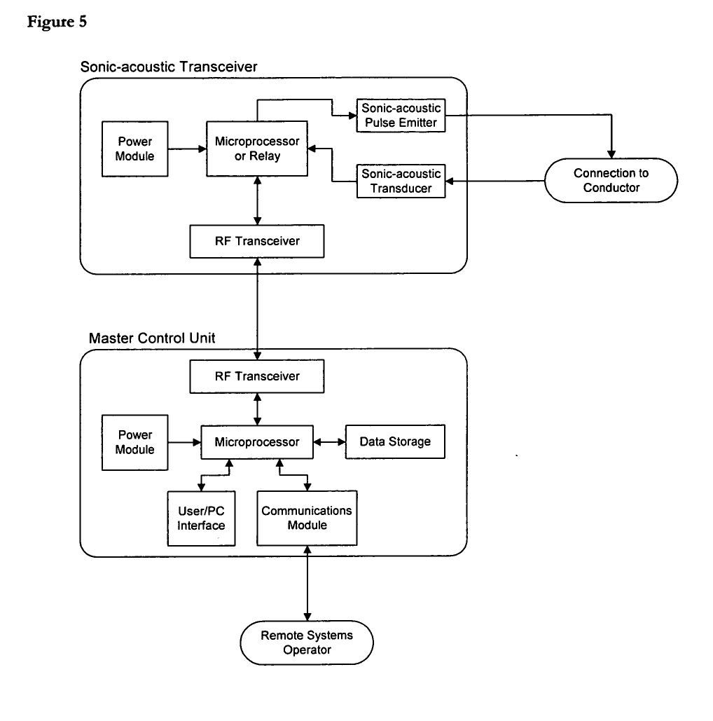

FIGS. 5, 6 and 7 are block diagrams describing three possible embodiments for the current invention all based on the description provided earlier and FIGS. 1 and 2. Needless to say other embodiments can be easily developed by on one knowledgeable in the art.

FIG. 5 is a block diagram showing the components of an exemplary sonic-acoustic transceiver and a master control unit and how they may be arranged and functionally attached to each other.

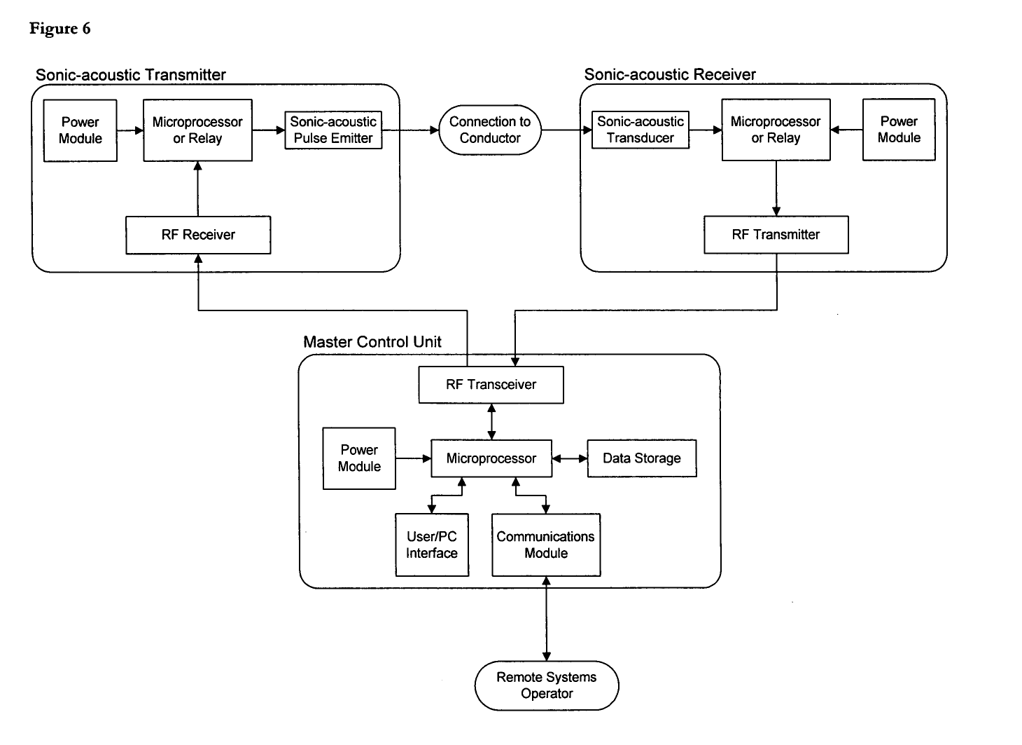

FIG. 6 is another block diagram showing the transmitter and receiver in separate modules, both communicating with the mater control unit.

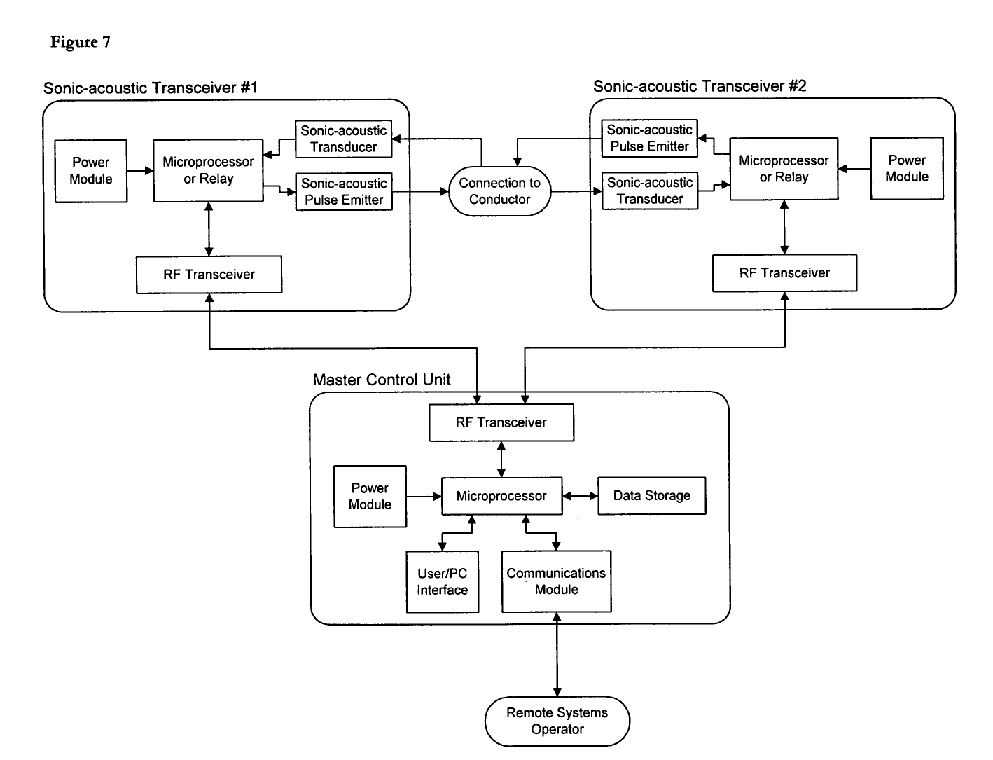

FIG. 7 is another block diagram showing an alternative arrangement of the transmitter and receiver communicating with the mater control unit.

It will be clear to those of skill that the embodiments described here only represent a selection of specific arrangements and that he invention may be practiced with various arrangements and combinations not explicitly described herein, but still within the scope of the invention.

I claim:

1. A temperature sensing device comprising:
a mounting clamp adapted for attachment to a line,
a sonar pulse generator affixed to the mounting clamp,
an acoustic sensor affixed to a mounting clamp,
a control module in communicably linked to the acoustic sensor,
a communication module communicably linked to the control module,
and a power module in communication with at least one of the aforementioned components.

2. The device of claim 1 wherein the control module comprises a CPU.

3. The device of claim 2 wherein the CPU controls pulse generation, measurement of reflected pulses, and communication via the communication module.

4. The device of claim 1 wherein the control module further comprises an ambient temperature sensor.

5. The device of claim 1 wherein the communication module comprises a radio-frequency transmitter.

6. The device of claim 5 wherein the communication module comprises a radio-frequency receiver.

7. The device of claim 1 wherein the power module comprises an energy storage means.

8. The device of claim 7 wherein the energy storage means comprises a battery.

9. The device of claim 7 wherein the energy storage means comprises a capacitor.

10. The device of claim 1 wherein the power module comprises an inductive coil.

11. The device of claim 1 wherein the power module comprises a wind driven turbine.

12. The device of claim 1 wherein the power module comprises a pendulum.

13. The device of claim 1 wherein the power module comprises a shape memory alloy.

14. The device of claim 1 wherein the power module comprises a solenoid.

15. The device of claim 1 wherein the power module comprises a photovoltaic cell.

16. The device of claim 1 wherein the power module comprises a direct wire tap to a power line.

17. The device of claim 1 wherein the control module is mechanically attached to one or more components of the device.

18. The device of claim 1 wherein the control module is not mechanically attached to one or more components of the device but is communicably linked via telemetry.

19. The device of claim 18 wherein the telemetry is achieved using radio frequency signals.

20. The device of claim 1 adapted for attachment to a suspended power line.
